(19) United States
(12) Patent Application Publication
(10) Pub. No.: US 2017/0276577 A1
(43) Pub. Date: Sep. 28, 2017

(54) COLOURING METHOD FOR WROUGHT ALUMINIUM ALLOY WELDED JOINT COLOUR METALLOGRAPHY

(71) Applicant: CRRC QINGDAO SIFANG CO., LTD., Qingdao, Shandong (CN)

(72) Inventors: Hao LU, Qingdao, Shandong (CN); Liwei XING, Qingdao, Shandong (CN); Decheng HAN, Qingdao, Shandong (CN)

(73) Assignee: CRRC QINGDAO SIFANG CO., LTD., Qingdao, Shandong (CN)

(21) Appl. No.: 15/509,081

(22) PCT Filed: Oct. 12, 2015
(86) PCT No.: PCT/CN2015/091748

§ 371 Date: Mar. 6, 2017

(30) Foreign Application Priority Data
Oct. 13, 2014 (CN) 201410537773.3

(51) Int. Cl. G01N 1/32; G01N 21/25

(52) U.S. Cl. CPC G01N 1/32; G01N 21/255

(57) ABSTRACT

A colouring method for wrought aluminium alloy welded joint colour metallography, comprising pre-etching and colouring, wherein the pre-etching comprises an acid etching processing step. The acid etching processing is as follows: an acid etching solution is heated to 55° C.-65° C., dripped onto a test piece surface for 50 s-60 s, then flushed with a large amount of deionized water and dried with hot air. The acid etching solution is an aqueous solution comprising 0.3-0.5 mol/L of Cl⁻, 1.4-1.8 mol/L of H⁺ and 0.3-0.5 mol/L of PO₄³⁻. The colouring is as follows: the test piece subjected to the pre-etching processing is completely immersed in a Weck's reagent, shaken slightly for 5-10 s, flushed with a large amount of deionized water after surface colouring and dried with hot air.

### CROSS REFERENCE OF RELATED APPLICATION

This application claims the priority of Chinese Patent Application No. 201410537773.3 filed on Oct. 13, 2014 with the Chinese Patent Office, entitled “Colouring Method for Wrought Aluminium Alloy Welded Joint Colour Metallography”, which is incorporated in this application by reference in its entirety.

### Field

The present invention relates to the technical field of metal material plating, particularly to a colouring method for wrought aluminum alloy welded joint color metallography.

### Background

Currently there are lots of means and methods for detecting material microstructure, such as scanning electron microscopy, transmission electron microscopy, electron probe, X-ray detection, high-powered metallographic microscopy and the like, all of which can be used for detecting material microstructure, but each instrument and method focus on the respective detection parameters. It is very common and effective to use high-powered metallographic microscopy for observing aluminum alloy microstructure, in particular the modification effect, as the engineers and technicians can predict and judge the performance of the metal and analyze the causes of various failures and destruction through the observation and analysis of the high-powered images. This above-mentioned process of detection and analysis is commonly referred to as metallurgical analysis. Color metallography technique, as one of the metallurgical analysis techniques, mainly uses chemical or physical methods to form a layer of an interference film of varying thickness on the metal surface. Under the interference effect of light, the interference film of varying thickness reflects different wavelengths and exhibits the complementary color of the respective interference wavelength, so that different parts of the metal exhibit different colors. It is most important for color metallographic analysis to prepare the color metallographic samples, because a false image may appear in the event of improper sample preparation, which may give wrong conclusions. Therefore, the quality of the prepared color metallographic sample plays a vital role in the detection and performance determination of the sample.

Aluminum alloy with low density, high strength, good formability and weldability has been widely used in aviation, high-speed trains and automobiles, and other fields, with the second widest application in industry after steel. As aluminum alloy is relatively soft, it is difficult to prepare metallographic samples.

The weldment and the welding wire have different components at the is position of a wrought aluminum alloy welded joint. The wrought aluminum alloy weldment, also known as the base metal (parent material) and mostly in a rolled state, is aluminum alloy whose structure and shape are changed by the process such as stamping, bending, rolling, extruding. The welding line (or welding seam) is aluminum alloy in a cast state. Due to the different components of the base metal and weld line at the position of a wrought aluminum alloy welded joint, the base metal and weld have different etching resistance to an etching solution. As a problem or defect of uneven etching of the base metal and weld line (welding seam) may occur using the pre-etching method used in the prior art to process wrought aluminum alloy welded joints. As a result, the color metallographic photos prepared are not clear, resulting in inaccurate analysis and test results.

The patent CN103471897A discloses a colouring method for aluminum alloy color metallography, comprising the steps of: (1) pre-etching: the polished aluminum alloy metallographic sample is immersed in an etching solution for 1-10 minutes, washed with running water and ethanol after the completion of the etching, and then dried; the etching solution is a solution obtained by dissolving sodium chloride or potassium chloride in phosphoric acid, or the etching solution is a solution prepared with phosphoric acid, nitric acid and water; (2) colouring. The method disclosed thereof has simple steps and a good colouring effect, can obtain clear grain structure, and can obtain clear microstructure image even without the use of polarized light and sensitive tone observation. However, as there is severe color metallographic etching of the weld line (or welding seam) in the fusion zone of the wrought aluminum alloy welded joint sample obtained by processing the sample with this method, it is impossible to see and/or distinguish the grain structure of the fusion zone section in the photos prepared.

### SUMMARY

An object of the present invention is to provide a colouring method for wrought aluminum alloy welded joint color metallography; sample preparation of is this method has a high success rate, high reproducibility and low cost, and the wrought aluminum alloy welded joint color metallography processed using this method has the advantages of a high contrast display, clear grain boundaries and high accuracy for the test results.

The technical solution of the present invention is: a colouring method for wrought aluminum alloy welded joint color metallography, including pre-etching and colouring, wherein the pre-etching comprises a step of acid etching process; the acid etching process is heating an acid etching solution to 55-65° C., dripping the solution on the sample surface and holding for 50-60 s, then washing it with a large amount of deionized water, and drying it with hot air; the acid etching solution is an aqueous solution containing 0.3-0.5 mol/L of Cl⁻; 1.4-1.8 mol/L of H⁺; 0.3-0.5 mol/L of PO₄³⁻;

The colouring is immersing the sample processed by the pre-etching completely into the Weck's reagent, gently shaking it for 5-10 s, rinsing it with a large amount of deionized water after the surface is colored, and drying it with hot air.

Weldments and welding wires have different components, and weldments are mostly in a rolled state while welds (weld line or welding seam) are in a cast state, which results in different resistance to acid etching. 6-series and 7-series wrought aluminum have etching resistance significantly higher than that of welds. The present invention uses an acid-etching solution with a low acidity for the acid etching process of the samples. It is much more difficult to handle the acid etching process, as the time period is short when there are clear grain boundaries simultaneously in the etched base metal and the etched weld line (or welding seam). After a lot of experiments, the inventors of the present invention found that when an acid etching solution having a low acidity is used to pre-etching the sample and the temperature for the acid etching process is controlled at 55-65° C., good etching results may appear in the base metal and welds simultaneously in a is certain period of time. During the acid etching process, if the time period for acid etching is short, the grain contours are not clear, and if the time for acid etching is too long, the grain boundaries are severely etched and many etching pits appear. The present invention controls the time for acid etching to 50-60 s, and thus is capable of obtaining color metallography with clear grains in both the base metal and welds.

When being immersed in the Weck's reagent to be colored, the sample is gently shaken a few times, which is favorable to the rapid and uniform colouring, and the grain structure of both the base metal and welds can be well presented. If there is no shaking, the colouring effect is poor, and the colouring time needed is multiplied.

The pre-etching further comprises a step of alkaline etching process; the alkaline etching process is immersing the sample processed by acid etching into an alkaline etching solution for 50-120 s, then rinsing it with a large amount of deionized water, and drying it with hot air; the alkaline etching solution is an aqueous solution containing 0.1-0.5 mol/L of OH⁻.

In the study, the applicant of the present invention surprisingly found that, an additional alkaline etching process of the sample processed by acid etching can further etch the metal between grain boundaries, obtaining samples with clearer grain boundary interfaces and a better colouring effect. The use of alkaline etching process can further etch the base metal and weld uniformly and avoid the phenomenon of local etching of the weld.

The acid etching process is heating the acid etching solution in water bath to 65° C., dripping the solution on the sample surface, after for 60 s then rinsing it with a large amount of deionized water, and drying it with hot air.

The alkaline etching process is heating the alkaline etching solution to 40-60° C. , immersing the sample processed by acid etching into the alkaline etching solution for 50-120 s, then rinsing it with a large amount of deionized water, and drying it with hot air.

The alkaline etching process is heating the alkaline etching solution to 50° C., immersing the sample processed by acid etching into the alkaline etching solution, carrying out ultrasonic vibration for 60-100 s, followed by rinsing it with a large amount of deionized water, and drying it with hot air. The ultrasonic frequency is 15-40 kHz.

Immersing the sample in the alkaline etching solution and carrying out ultrasonic vibration have cavitation and etching effects. Ultrasonic wave generates a large number of tiny bubbles in the alkaline etching solution. These bubbles form and grow in the negative pressure zone of the longitudinal ultrasonic wave propagation and burst rapidly in the positive pressure zone. The process of forming, growing and rapid bursting of tiny bubbles is so-called cavitation phenomenon. When cavitation phenomenon occurs, an instantaneous high pressure over 1000 atm builds up at the moment when the tiny bubbles form, grow and rapidly burst. The continual instantaneous high pressure, acting like a series of small bombs, continually bombards the metal at grain boundary of the aluminum alloy that is more easily to be etched, and strips off the grain boundary metal of the aluminum alloy rapidly, such that the grain boundary interfaces of the aluminum alloy may become clearer. Meanwhile, in the alkaline solution, cavitation can also twist, distort and cause chemical instability of the grain boundaries and crystal structures at the base metal and welds of the aluminum alloy welded joints, make the galvanic etching easier between the grain boundaries and crystals, and aggravate the electrochemical etching of the sample. Ultrasonic cavitation allows both of the welds and base metal to obtain the same etching effect in an alkaline solution with a low concentration.

The acid etching solution is an aqueous solution containing 0.39-0.46 mol/L of Cl⁻; 1.43-1.79 mol/L of H⁺; 0.35-0.47 mol/L of PO₄³⁻; preferably the acid etching solution is an aqueous solution containing 0.40-0.44 mol/L of Cl⁻; 1.50-1.73 mol/L of H⁺; 0.38-0.45 mol/L of PO₄³⁻, and more preferably the acid is etching solution is an aqueous solution containing 0.05 mol/L of Na⁺ or K⁺; 0.43 mol/L of Cl⁻; 1.64 mol/L of H⁺; 0.42 mol/L of PO₄³⁻.

The alkaline etching solution is an aqueous solution containing 0.1-0.3 mol/L of OH⁻, preferably the alkaline etching solution is an aqueous solution containing 0.12-0.28 mol/L of OH⁻, and more preferably the alkaline etching solution is an aqueous solution containing 0.125 mol/L of OH⁻ and 0.125 mol/L of Na⁺ or K⁺.

The acid etching process is carried out within 2-5 hours after the preparation of the acid etching solution is completed, and preferably the acid etching process is carried out within 4 hours after the preparation of the acid etching solution is completed.

As the acid etching solution contains volatile hydrochloric acid, if the standing time is too long after the preparation, volatilization of the hydrochloric acid will occur and affects the acid etching results. Therefore, during the acid etching process, it is generally required that the acid etching solution is immediately used after the preparation, since if the standing time of the acid etching solution is more than 5 hours, the acid etching effect will be degraded, resulting in unclear grain boundaries in the metallographic photos.

The method for preparing the acid etching solution is: adding 0.5-1.8 g of potassium chloride, 25-32 ml of 35% phosphoric acid solution and 10 ml of 37% hydrochloric acid solution to 280 ml of deionized water and mixing them to obtain the acid etching solution; preferably adding 1.2 g of potassium chloride, 30 ml of 35% phosphoric acid solution and 10 ml of 37% hydrochloric acid solution to 280 ml of deionized water and mixing them to obtain the acid etching solution.

The method for preparing the alkaline etching solution is: adding 1-3 g of solid NaOH to 250 ml of deionized water and mixing them to obtain the alkaline etching solution; preferably adding 1.25 g of solid NaOH to 250 ml of deionized water and mixing them to obtain the alkaline etching solution.

The advantages and positive effects of the present invention are: the grain is structures of both the base metal and welds (weld line or welding seam) can be well presented because the welds and base metal of the wrought aluminum alloy welded joint can be pre-etched synchronously and can be colored rapidly and evenly using the above technical solution. Sample preparation of this method has a high success rate, high reproducibility and low cost, and the wrought aluminum alloy welded joint color metallography processed using the present method has the advantages of a high contrast display, clear grain boundaries and high accuracy of the test results.

### BRIEF DESCRIPTION OF THE DRAWINGS

FIG. 1 is a metallographic photo of the welds (welding seam) colored filled with welding wire ER4043 according to the present method;

FIG. 2 is a metallographic photo of the welds filled with welding wire ER5356 by multi-pass and multi-layer welding colored according to the present method;

FIG. 3 is a metallographic photo of the heat-affected zone of welded 7N01 aluminum alloy colored according to the present method;

FIG. 4 is a metallographic photo of 7N01 wrought aluminum after colouring according to the present method;

FIG. 5 is a metallographic photo of the fusion zone of 7N01 wrought aluminum and filler wire ER5356 colored according to the present method;

FIG. 6 is a metallographic photo of 6N01 wrought aluminum colored according to the present method;

FIG. 7 is a metallographic photo of the fusion zone of 6N01 wrought aluminum and filler wire ER4043 colored according to the present method;

FIG. 8 is a metallographic photo of the fusion zone of 6N01 wrought aluminum and filler wire ER5356 colored according to the present method;

FIG. 9 is a metallographic photo of the fusion zone of 6N01 wrought is aluminum and filler wire ER4043 colored according to the method of Example 5 of the invention CN103471897A.

### DETAILED DESCRIPTION

### EXAMPLE 1

1) 0.5 g of potassium chloride, 32 ml of 35% phosphoric acid solution and 10 ml of 37% hydrochloric acid solution were added into and mixed with 280 ml of deionized water to obtain the acid etching solution;

2) The acid etching solution was heated to 55° C., and dripping the solution on the ground and polished surface of the weld sample filled with welding wire ER4043, after 60 s, the sample was washed with a large amount of deionized water and dried with hot air;

3) The sample processed by acid etching was completely immersed into the Weck's reagent, gently shaken for 5 s, washed with a large amount of deionized water after the surface was colored, and dried with hot air.

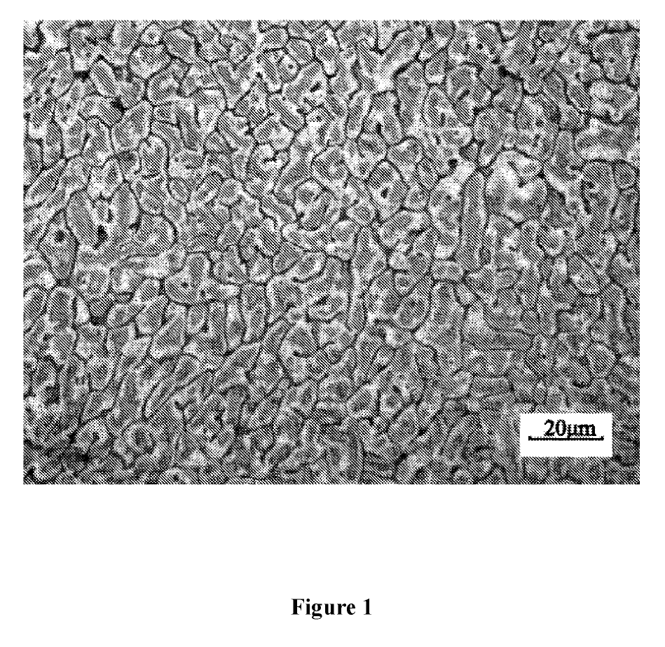

The obtained metallographic photo is shown in FIG. 1. From FIG. 1 clear grain boundaries and grain morphology of the weld seam filled with welding wire ER4043 can be seen.

### EXAMPLE 2

1) 1.8 g of potassium chloride, 32 ml of 35% phosphoric acid solution and 10 ml of 37% hydrochloric acid solution were added into and mixed with 280 ml of deionized water to obtain the acid etching solution;

2) 1 g of solid NaOH was added into and mixed with 250 ml of deionized water to obtain the alkaline etching solution;

3) The alkaline etching solution was heated to 65° C., and dripping the solution on the grounded and polished surface of the weld sample filled with welding wire ER5356 by multi-pass and multi-layer welding, after 60 s, the sample was washed with a large amount of deionized water and dried with hot air;

4) The alkaline etching solution was heated to 50° C., and the sample processed by acid etching was immersed into the alkaline etching solution for 100 s, then washed with a large amount of deionized water, and dried with hot air;

5) The sample processed by alkaline etching was completely immersed into the Weck's reagent, gently shaken for 10 s, washed with a large amount of deionized water after the surface was colored, and dried with hot air.

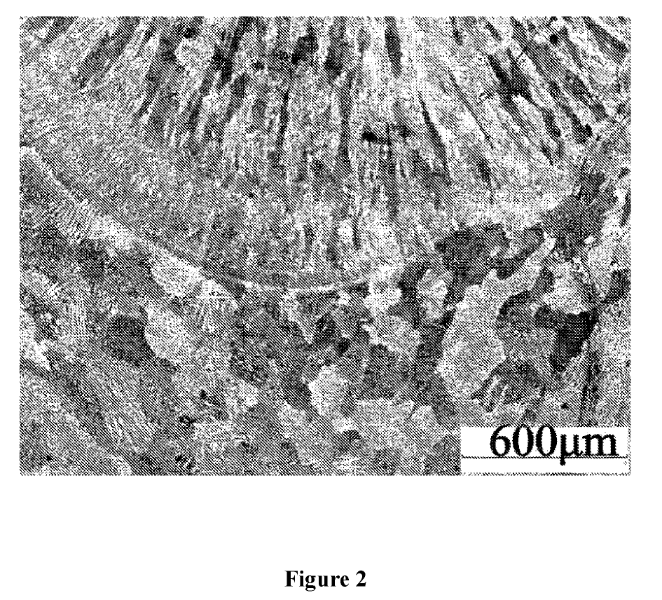

The obtained metallographic photo is shown in FIG. 2, and it can be seen clearly from FIG. 2 that the weld fusion zone of the weld filled with welding wire ER5356 by multi-pass and multi-layer welding has small grains, and the grains are columnar-shaped and arranged radially from the center of the fusion zone to the periphery. The base metal has larger grains, and the grain boundaries and grain structures of the base metal and weld are clearly displayed.

### EXAMPLE 3

1) 1.2 g of potassium chloride, 25 ml of 35% phosphoric acid solution and 10 ml of 37% hydrochloric acid solution were added into and mixed with 280 ml of deionized water to obtain the acid etching solution;

2) 3 g of the solid NaOH was added into and mixed with 250 ml of deionized water to obtain the alkaline etching solution;

3) The acid etching solution was heated to 60° C., and dripping the solution on the ground and polished sample surface of the heat affected zone of welded 7N01 aluminum alloy, after for 50 s, the sample was washed with a large amount of deionized water and dried with hot air;

4) The alkaline etching solution was heated to 40° C., and the sample processed by acid etching was immersed into the alkaline etching solution, subjected to ultrasonic vibration for 60 s, then washed with a large amount of deionized water, and dried with hot air. The ultrasonic frequency is 15 kHz.

5) The sample processed by alkaline etching was completely immersed into the Weck's reagent, gently shaken for 5 s, washed with a large amount of deionized water after the surface was colored, and dried with hot air.

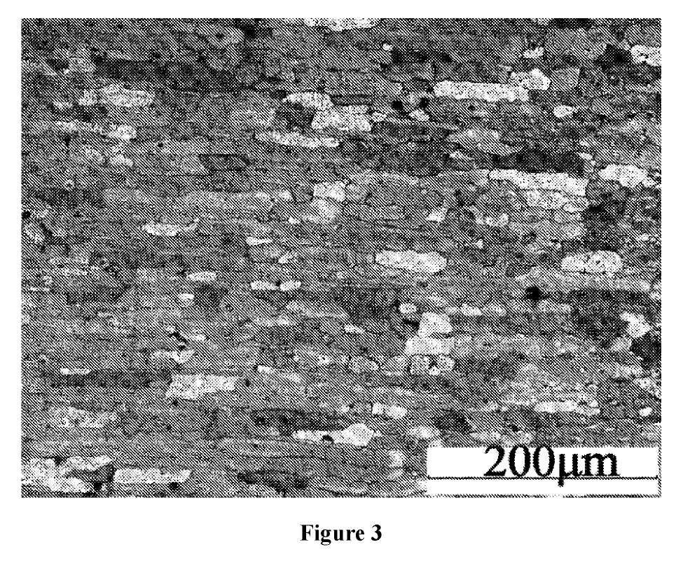

The obtained metallographic photo is shown in FIG. 3, and clear grain boundaries and grain morphology of the heat affected zone of welded 7N01 aluminum alloy after welding can be seen from FIG. 3.

### EXAMPLE 4

1) 1.2 g of potassium chloride, 30 ml of 35% phosphoric acid solution and 10 ml of 37% hydrochloric acid solution were added into and mixed with 280 ml of deionized water to obtain the acid etching solution;

2) 1.25 g of the solid NaOH was added into and mixed with 250 ml of deionized water to obtain the alkaline etching solution;

3) The acid etching solution was heated to 65° C., and dripping the solution on the ground and polished surface of the 7N01 wrought aluminum sample, after 60 s, the sample was washed with a large amount of deionized water and dried with hot air;

4) The alkaline etching solution was heated to 50° C., and the sample processed by acid etching was immersed into the alkaline etching solution, subjected to ultrasonic vibration for 100 s, then washed with a large amount of deionized water, and dried with hot air, the ultrasonic frequency being 40 kHz;

5) The sample processed by alkaline etching was completely immersed into the Weck's reagent, gently shaken for 5 s, washed with a large amount of deionized water after the surface was colored, and dried with hot air.

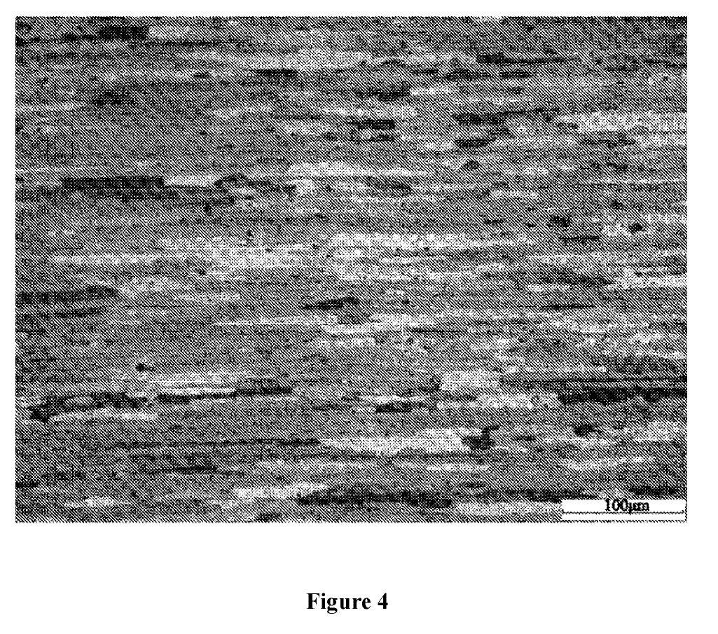

The obtained metallographic photo is shown in FIG. 4, and clear grain boundaries and grain morphology of 7N01 wrought aluminum can be seen from FIG. 4.

### EXAMPLE 5

1) 1.2 g of potassium chloride, 30 ml of 35% phosphoric acid solution and 10 ml of 37% hydrochloric acid solution were added into and mixed with 280 ml of deionized water to obtain the acid etching solution;

2) 1.25 g of the solid NaOH was added into and mixed with 250 ml of deionized water to obtain the alkaline etching solution;

3) The acid etching solution was heated to 65° C., and dripping the solution on the ground and polished sample surface of the fusion zone between 7N01 wrought aluminum and filler wire ER5356, after 60 s, it was washed with a large amount of deionized water and dried with hot air;

4) The alkaline etching solution was heated to 50° C., and the sample processed by acid etching was immersed into the alkaline etching solution, subjected to ultrasonic vibration for 100 s, then washed with a large amount of deionized water, and dried with hot air. The ultrasonic frequency being 40 kHz;

5) The sample processed by alkaline etching was completely immersed into the Weck's reagent, gently shaken for 5 s, washed with a large amount of deionized water after the surface was colored, and dried with hot air.

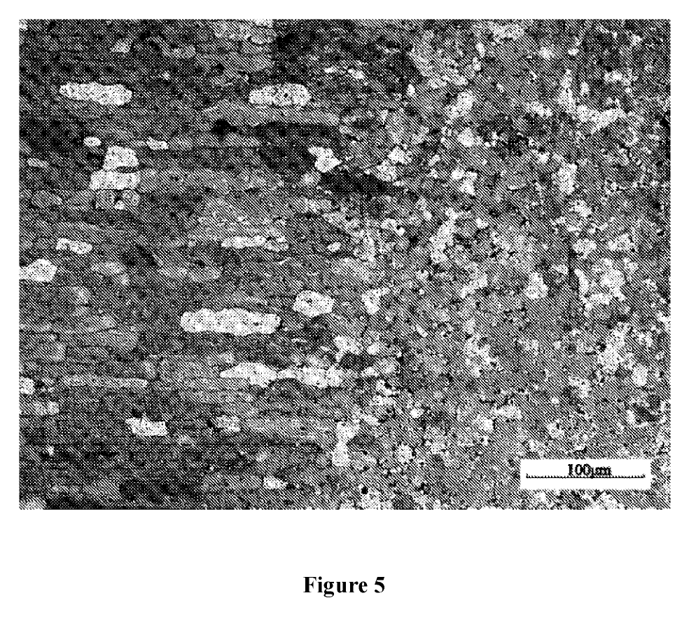

The obtained metallographic photo is shown in FIG. 5, and clear grain boundaries and grain morphology of the fusion zone of 7N01 wrought aluminum and filler wire ER5356 can be seen from FIG. 5. By comparing FIGS. 4 and 5 it can be seen that the base metal, the 7N01 wrought aluminum has larger grains which are regularly arranged as long strips, while the fusion zone of weld filler wire ER5356 has smaller grains which are arranged as dots. The base metal and weld are etched evenly and uniformly with clear grain boundaries.

### EXAMPLE 6

1) 1.5 g of potassium chloride, 32 ml of 35% phosphoric acid solution and 10 ml of 37% hydrochloric acid solution were added into and mixed with 280 ml of deionized water to obtain the acid etching solution;

2) The acid etching solution was heated to 65° C., and dripping the solution on the ground and polished surface of the 6N01 wrought aluminum sample, after 50 s, the sample was washed with a large amount of deionized water and dried with hot air;

3) The sample processed by acid etching was completely immersed into the Weck's reagent, gently shaken for 5 s, washed with a large amount of deionized water after the surface was colored, and dried with hot air.

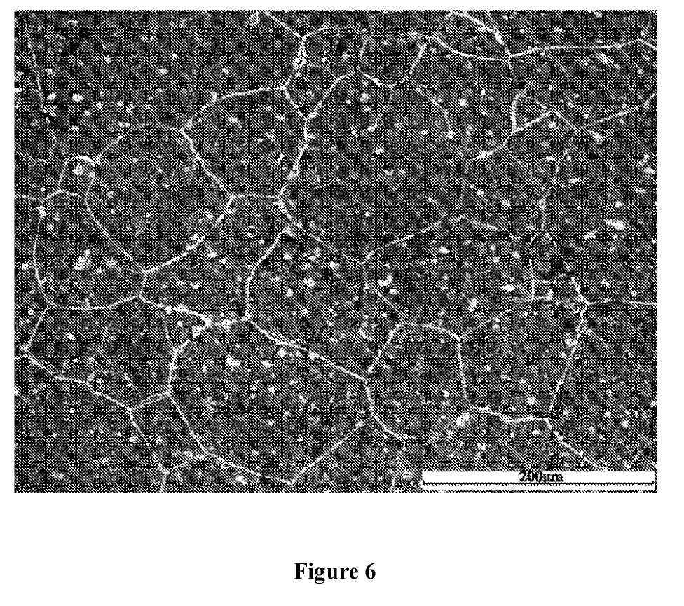

The obtained metallographic photo is shown in FIG. 6, and clear grain boundaries and grain morphology of 6N01 wrought aluminum can be seen from FIG. 6.

### EXAMPLE 7

1) 0.5 g of potassium chloride, 30 ml of 35% phosphoric acid solution and 10 ml of 37% hydrochloric acid solution were added into and mixed with 280 ml of deionized water to obtain the acid etching solution;

2) 1.25 g of the solid NaOH was added into and mixed with 250 ml of deionized water to obtain the alkaline etching solution;

3) The acid etching solution was heated to 60° C., and dripping the solution on the ground and polished sample surface of the fusion zone of 6N01 wrought aluminum and filler wire ER4043, after 60 s, the sample was washed with a large amount of deionized water and dried with hot air;

4) The alkaline etching solution was heated to 50° C., and the sample processed by acid etching was immersed into the alkaline etching solution, subjected to ultrasonic vibration for 100 s, then washed with a large amount of deionized water, and dried with hot air, the ultrasonic frequency being 40 kHz;

5) The sample processed by alkaline etching was completely immersed into the Weck's reagent, gently shaken for 10 s, washed with a large amount of deionized water after the surface was colored, and dried with hot air.

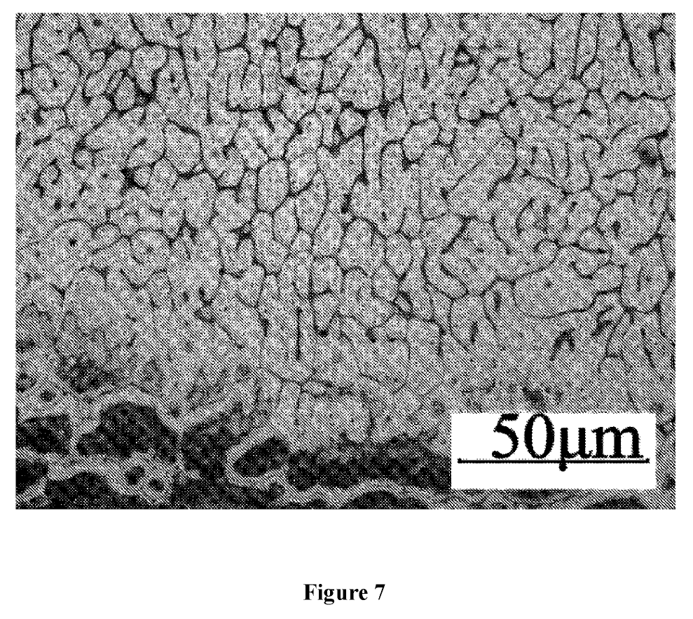

The obtained metallographic photo is shown in FIG. 7. As shown in is FIG. 6, 6N01 wrought aluminum has large grains and clear grain boundaries. As shown in FIG. 1, the fusion zone of filler wire ER4043 has small grains which are irregularly arranged as worm-shaped. The upper part of FIG. 7 is the welds (weld seams) and the fusion zone of filler wire ER4043; the lower part of FIG. 7 is the base metal, 6N01 wrought aluminum. In FIG. 7, clear grain boundaries and grain morphology can be seen in both the base metal and welds. The simultaneous etching of the base metal and weld has a good effect.

### EXAMPLE 8

1) 1.2 g of potassium chloride, 30 ml of 35% phosphoric acid solution and 10 ml of 37% hydrochloric acid solution were added into and mixed with 280 ml of deionized water to obtain the acid etching solution;

2) 1.25 g of the solid NaOH was added into and mixed with 250 ml of deionized water to obtain the alkaline etching solution;

3) The acid etching solution was heated to 60° C., and dripping the solution on the ground and polished sample surface of the fusion zone of 6N01 wrought aluminum and filler wire ER5356 and holding for 60 s, the sample was washed with a large amount of deionized water and dried with hot air;

4) The alkaline etching solution was heated to 50° C., and the sample processed by acid etching was immersed into the alkaline etching solution, subjected to ultrasonic vibration for 100 s, then washed with a large amount of deionized water, and dried with hot air, the ultrasonic frequency being 30 kHz;

5) The sample processed by alkaline etching was completely immersed into the Weck's reagent, gently shaken for 10 s, washed with a large amount of deionized water after the surface was colored, and dried with hot air.

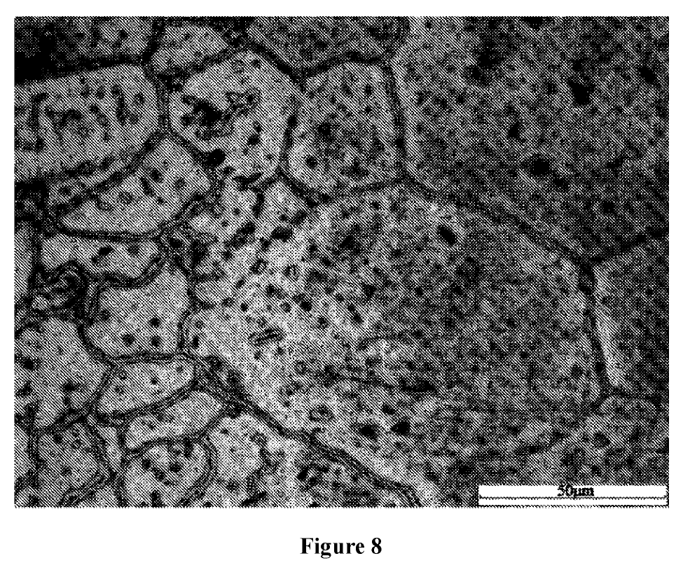

The obtained metallographic photo is shown in FIG. 8, and it can be seen from FIG. 8 that the right side is the base metal of 6N01 wrought aluminum with large grains, and the left side is the weld fusion zone of filler wire ER5356 with small grains. The grain boundaries and grain morphology of the base metal is and weld can be clearly seen from FIG. 8.

### COMPARATIVE EXPERIMENT EXAMPLE 1

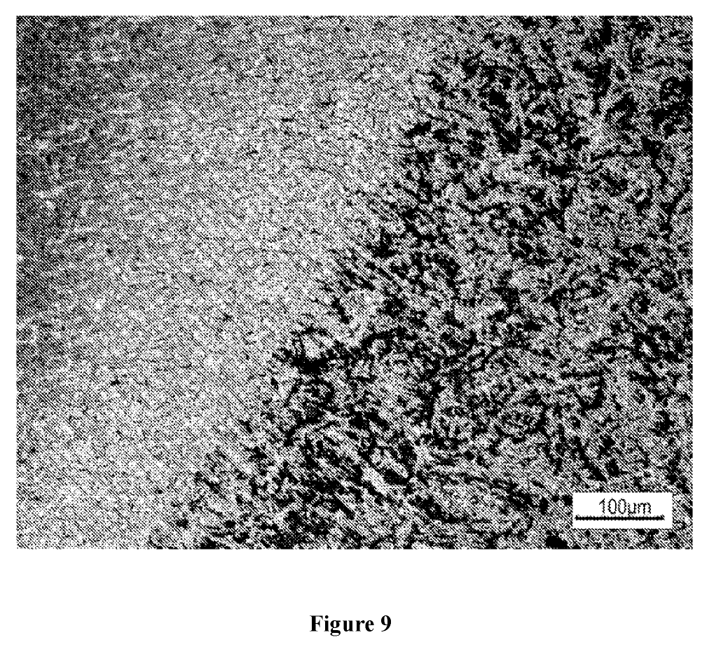

The fusion zone of 6N01 wrought aluminum and filler wire ER4043 was colored using the method used in Example 5 of the patent CN 103471897A, and the obtained color metallographic photo is shown in FIG. 9. As can be seen from FIG. 9, part of the base metal of 6N01 wrought aluminum was not etched, the grain contours are not clear, and clear grain boundaries and grain morphology can not be displayed, while as the weld part of the fusion zone of filler wire ER4043 was etched excessively and there were many etching pits, the grain structure can not be distinguished either.

The examples of the present invention have been described in detail above, but the content stated is only preferred examples of the present invention, and can not be considered as limitation to the scope of the present invention. All the equivalent modifications and improvements that are made according to the claims of the present invention fall within the scope encompassed by the present invention.

1. A colouring method for wrought aluminum alloy welded joint color metallography comprising pre-etching and colouring, characterized in that: the pre-etching comprises a step of acid etching process; the acid etching process is heating an acid etching solution to 55-65° C., dripping the solution on the sample surface, after 50-60 s washing the sample with a large amount of deionized water, and drying the sample with hot air; the acid etching solution is an aqueous solution containing 0.3-0.5 mol/L of Cl⁻; 1.4-1.8 mol/L of H⁺; 0.3-0.5 mol/L of PO₄³⁻;
The colouring is immersing the sample processed by the pre-etching completely into the Weck's reagent, gently shaking it for 5-10 s, rinsing it with a large amount of deionized water after the surface is colored, and drying it with hot air.

2. The colouring method for wrought aluminum alloy welded joint color metallography according to claim 1, characterized in that: the pre-etching further comprises a step of alkaline etching process; the alkaline etching process is immersing the sample processed by the acid etching into an alkaline etching solution for 50-120 s, then rinsing the sample with a large amount of deionized water, and drying it with hot air; the alkaline etching solution is an aqueous solution containing 0.1-0.5 mol/L of OH⁻.

3. The colouring method for wrought aluminum alloy welded joint color metallography according to claim 1, characterized in that: the acid etching process is heating the acid etching solution to 65° C. by a water bath, dripping the solution on the sample surface, after 60 s rinsing it with a large amount of deionized water, and drying it with hot air.

4. The colouring method for wrought aluminum alloy welded joint color metallography according to claim 2, characterized in that: the alkaline etching process is heating the alkaline etching solution to 40-60° C., immersing the sample processed by the acid etching into the alkaline etching solution for 50-120 s, then rinsing it with a large amount of deionized water, and drying it with hot air.

5. The colouring method for wrought aluminum alloy welded joint color metallography according to claim 4, characterized in that: the alkaline etching process is heating the alkaline etching solution to 50° C., immersing the sample processed by the acid etching into the alkaline etching solution, carrying out ultrasonic vibration for 60-100 s, then rinsing it with a large amount of deionized water, and drying it with hot air, the ultrasonic frequency being 15-40 kHz.

6. The colouring method for wrought aluminum alloy welded joint color metallography according to claim 1, characterized in that: the acid etching solution is an aqueous solution containing 0.39-0.46 mol/L of Cl⁻; 1.43-1.79 mol/L of H⁺; 0.35-0.47 mol/L of PO₄³⁻; preferably the acid etching solution is an aqueous solution containing 0.40-0.44 mol/L of Cl⁻; 1.50-1.73 mol/L of H⁺; 0.38-0.45 mol/L of PO₄³⁻, and more preferably the acid etching solution is an aqueous solution containing 0.05 mol/L of Na⁺ or K⁺; 0.43 mol/L of Cl⁻; 1.64 mol/L of H⁺; 0.42 mol/L of PO₄³⁻.

7. The colouring method for wrought aluminum alloy welded joint color metallography according to claim 2, characterized in that: the alkaline etching solution is an aqueous solution containing 0.1-0.3 mol/L of OH⁻, preferably the alkaline etching solution is an aqueous solution containing 0.12-0.28 mol/L of OH⁻, and more preferably the alkaline etching solution is an aqueous solution containing 0.125 mol/L of OH⁻ and 0.125 mol/L of Na⁺ or K⁺.

8. The colouring method for wrought aluminum alloy welded joint color metallography according to claim 1, characterized in that: the acid etching process is carried out within 2-5 hours after the preparation of the acid etching solution is completed, and preferably the acid etching process is carried out within 4 hours after the preparation of the acid etching solution is completed.

9. The colouring method for wrought aluminum alloy welded joint color metallography according to claim 1, characterized in that: the method for preparing the acid etching solution is: adding 0.5-1.8 g of potassium chloride, 25-32 ml of 35% phosphoric acid solution and 10 ml of 37% hydrochloric acid solution to 280 ml of deionized water and mixing them to obtain the acid etching solution; preferably adding 1.2 g of potassium chloride, 30 ml of 35% phosphoric acid solution and 10 ml of 37% hydrochloric acid solution to 280 ml of deionized water and mixing them to obtain the acid etching solution.

10. The colouring method for wrought aluminum alloy welded joint color metallography according to claim 2, characterized in that: the method for preparing the alkaline etching solution is: adding 1-3 g of solid NaOH to 250 ml of deionized water and mixing them to obtain the alkaline etching solution; preferably adding 1.25 g of solid NaOH to 250 ml of deionized water and mixing them to obtain the alkaline etching solution.
